(19) United States
(12) Patent Application Publication
(10) Pub. No.: US 2010/0047427 A1
(43) Pub. Date: Feb. 25, 2010

(54) MODIFIED SUGAR AND MODIFIED FAT FROZEN DESSERT

(75) Inventor: Xueqin Du, New South Wales (AU)

Correspondence Address: MERCHANT & GOULD PC, P.O. BOX 2903, MINNEAPOLIS, MN, 55402-0903, US

(73) Assignee: Montec International Limited, Sydney (AU)

(21) Appl. No.: 12/306,992

(22) PCT Filed: Jun. 21, 2007
(86) PCT No.: PCT/AU07/00866

§ 371 Date: Oct. 28, 2009

(30) Foreign Application Priority Data
Jul. 3, 2006 (AU) 2006903569

(51) Int. Cl. A23G 9/34; A23G 9/32; A23G 9/40

(52) U.S. Cl. 426/567; 426/565; 426/519; 426/585

(57) ABSTRACT

The present invention relates generally to frozen dairy products made with modified milk filled with vegetable oil that is preferably naturally high in monounsaturated fatty acids (MUFA). The invention further makes use of carbohydrates having a low glycemic index in place of sucrose. As well as being nutritionally unique, the product achieves a stability, taste and organoleptic quality of a regular frozen dessert such as ice cream comprising regular milk fat and sugar.

### CROSS-REFERENCE TO RELATED APPLICATIONS

The present application claims priority from Australian Provisional Patent Application No 2006903569 filed on 3 Jul. 2006, the content of which is incorporated herein by reference.

### FIELD OF THE INVENTION

The present invention relates generally to frozen dairy products made with modified milk filled with vegetable oil that is preferably naturally high in monounsaturated fatty acids (MUFA). The invention further makes use of carbohydrates having a low glycemic index in place of sucrose. As well as being nutritionally unique, the product achieves a stability, taste and organoleptic quality of a regular frozen dessert such as ice cream comprising regular milk fat and sugar.

### BACKGROUND OF THE INVENTION

Frozen desserts such as ice cream are regularly made with not less than 10% milk fat which is naturally high in saturated fats. It is now known however that saturated fatty acids, cholesterols and trans fatty acids raise serum low density lipoprotein cholesterol (LDL-c) levels resulting in an increased risk of coronary heart disease.

Since the late 1980's there has been a substantial effort to produce no fat and low fat frozen deserts such as ice cream having the same taste and organoleptic qualities as a regular ice cream. It has been found, however that low fat/no fat frozen desserts are particularly difficult to make. The complex foam structure of frozen dairy desserts comprises water, air and fats, and when milk fats are removed from whole milk, the organoleptic properties such as mouth-feel and flavour of the remaining “skim milk” are often unacceptable to consumers of frozen dairy products.

Early efforts to provide non-fat frozen dairy desserts were directed to replacing the regular milk fat normally present in ice cream with additional non-fat milk solids. To that end the solids content normally provided by butterfat can be replaced by a combination of increased non-fat milk solids and low dextrose equivalent (DE) corn syrup solids, and yet these were without commercial success because of a short shelf-life and stability issues.

Alternate efforts have used non-fat bulking agents such as sugar acid esters but desserts made with these agents are found to have undesirable flavour and mouth feel characteristics, for example they are frequently gritty, chalky, or waxy and have poor melting characteristics.

Examples of reduced fat ice cream are provided in U.S. Pat. No. 5,645,881 which describes a reduced fat ice cream prepared by replacing some or all of the fat in an ice cream recipe with a butter fat mimetic comprising a fatty acid-esterified propoxylated glycerin composition. U.S. Pat. No. 4,510,166 describes the use of converted starches such as dextrins, acid-converted starches, enzyme-converted starches and oxidized starches, to replace fat in food products such as mayonnaise and ice cream.

Reduced sugar, sugar free, low GI (glycaemic index) and reduced calorie frozen desserts are another “health” category of frozen desserts. To utilize non-sugar sweetener ingredients in frozen desserts, the bulking qualities of sugar as well as other properties like proper freezing point depression need to be replaced. Some ice cream products have a reduced sugar content and include other sweeteners instead, however the fat component varies from product to product, and usually includes mainly milk-fats (with or without fat substitutes) to retain the creamy taste of traditional ice creams.

In one example, a Nestle™ ice cream, “Carb Smart” contains a total carbohydrate of 4.2%, with a GI value as low as 7, well below the low GI range of <55. The Nestle™ product however contains a milk fat of 2.7%.

Olinger et al, U.S. Pat. No. 5,527,554, describes a reduced calorie frozen desert comprising a combination of lactitol and hydrogenated starch hydrolysate (HSH) as a bulk sweetener to replace sucrose/corn syrup solids. Olinger et al. state that this combination provides taste and texture qualities that are at least as preferable as conventional products sweetened with sucrose and corn syrup solids and is superior to that of polydextrose/maltodextrin/sorbitol and that of polydextrose/lactitol in terms of overrun, hardness and melting properties. However the HSH component of up to 15% has a dextrose equivalent (DE) value up to 80, making it likely to fall out of the low GI range of less than 55. In addition, the product contains milk fat in an amount of about 4% to 8%.

### SUMMARY OF INVENTION

The present invention relates to a composition of a frozen dessert product, or a mixture for making the product, that comprises an amount of non fat milk solids, high monounsaturated vegetable oil and low GI carbohydrate ingredients. Preferably the mixture is prepared as a liquid or a powder and is suitable for making a frozen or soft-serve product.

The inventors have sought to provide a frozen dessert product which has a similar taste and mouth feel to a frozen dessert product made with the same percentage of whole milk fat and using conventional sugar. Most, preferably the frozen dessert product of the present invention also provides the benefits of having a low GI, reduced calories, and preferably a healthy fat profile, that is low in saturated fat, low in cholesterol, and which includes no trans fatty acids.

It is to be understood that the frozen dessert product of the present invention is preferably served frozen, semi-frozen or as a soft-serve product. The term “frozen dessert product” as used herein is intended to include products such as, for example, ice cream (being spoonable or in block form), soft serve dairy products, semi-frozen dairy products, soft serve or frozen mousse, and milkshakes or thickshakes which comprise a frozen, semi-frozen or soft serve dairy-type product, or the like.

The frozen dessert product of the present invention (i.e. the product suitable for consumption) is not intended to include liquid milk or cream or other regularly consumed liquid products per se. The frozen dessert product of the present invention is preferably kept at a temperature below the recommended temperature of a regular refrigerator i.e. below 1-4° C. Most preferably, the frozen dessert is an ice cream that is spoonable or a soft-serve ice cream that might be served in a cone, for example. Nevertheless, the mixture that is formed to make the frozen dessert product can be a liquid or alternatively a powder. Furthermore, the mixture or frozen dessert product can be used to make other products such as milkshakes and thickshakes.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Accordingly in the first aspect the present invention provides a frozen dessert composition, the composition comprising skim milk solids, milk derived solids, vegetable oil high in monounsaturated fatty acids, low GI carbohydrate ingredients, stabilisers and emulsifiers. Preferably the composition also comprises milk flavour enhancers.

Preferably, the present invention provides a frozen dessert composition comprising

(a) skim milk solids in a total amount of about 4.5% to 10.9% by weight of the composition,
(b) milk derived solids in a total amount of about 2.7% to 7.7% by weight of the composition,
(c) vegetable oil high in monounsaturated fatty acids in a total amount of about 4.5% to 6.5% by weight of the composition,
(d) low GI carbohydrates in an amount of about 9% to 17% by weight of the composition
(e) one or more stabiliser,
(f) one or more emulsifier, and
(g) optionally one or more milk flavour enhancer.

The composition can be in the form of a mixture suitable for making a frozen dessert or the frozen dessert per se, or any phase in between. The vegetable oil is high monounsaturated vegetable oil, most preferably the vegetable oil is 100% oleic acid non-hydrogenated vegetable oil.

The carbohydrate ingredients have a low GI, and preferably the carbohydrate ingredients also provide reduced calories. The GI (glycemic index, FAO/WHO Carbohydrate in Human Nutrition. Rome 1998) is a ranking of carbohydrates on a scale from 0 to 100 according to the extent to which they raise blood sugar levels after eating, relative to a reference food-glucose which is given a GI value of 100. As used herein, “low GI” is considered to be a GI of less than 55. In one embodiment the carbohydrates comprise a mixture of natural sugar alcohol, dietary fibre and other carbohydrates.

The frozen dessert composition of the present invention is distinguished from other frozen desserts by its high monounsaturated fatty acid vegetable oil content (preferably all non-hydrogenated) after removing all milk fat, its low cholesterol and low saturated fatty acids content, and its reduced GI and reduced calorie carbohydrate ingredients including dietary fibre. All these features together may enhance health benefits that currently available products cannot offer.

The end product of the present invention is distinguished from other “health” frozen dessert products as it approximates a taste and mouthfeel of dairy products such as mousse and ice cream which comprise higher percentages of milk fat.

In a second aspect the present invention provides a use of a frozen dessert composition, comprising

(a) skim milk solids in a total amount of about 4.5% to 10.9% by weight of the composition,
(b) milk derived solids in a total amount of about 2.7% to 7.7% by weight of the composition,
(c) vegetable oil high in monounsaturated fatty acids in a total amount of about 4.5% to 6.5% by weight of the composition,
(d) low GI carbohydrates in an amount of about 9% to 17% by weight of the composition,
(e) one or more stabiliser,
(f) one or more emulsifier, and
(g) optionally one or more flavour,
in the preparation of a mixture suitable for making a frozen dessert product.

In a third aspect the present invention provides a method of making a frozen dessert composition comprising forming a mixture by combining together (i) one or more stabiliser and emulsifiers, (ii) one or more monounsaturated vegetable oil, (iii) one or more skim milk and milk derived solids, and (iv) one or more carbohydrate ingredients.

The frozen dessert mixture used for making the final product of the present invention can be, for example, in liquid form or powder form.

Liquid mixture can be prepared by including the step of pasteurisation or UHT (ultra high temperature) treatment of the frozen dessert composition. Powdered mixture can be prepared by including the step of using a spray dry treatment of the frozen dessert composition.

Accordingly, in another aspect the present invention provides a method of making a frozen dessert product comprising forming a mixture by combining together (i) one or more stabiliser and emulsifiers, (ii) one or more monounsaturated vegetable oil, (iii) one or more skim milk and milk derived solids, and (iv) one or more carbohydrate ingredients, pasteurizing the mixture, and preferably homogenising the pasteurized mixture and preferably freezing the pasteurized mixture. Other steps can include cooling, aging and whipping.

In another embodiment, a frozen dessert product can be made by making a frozen dessert composition comprising forming a mixture by combining together (i) one or more stabiliser and emulsifiers, (ii) one or more monounsaturated vegetable oil, (iii) one or more skim milk and milk derived solids, and (iv) one or more carbohydrate ingredients; UHT treating the mixture, and preferably homogenising the UHT treated mixture, and preferably aseptically packaging the UHT treated mixture, and then preferably freezing the ready-to-use mixture. Other steps can include cooling, aging and whipping.

In another embodiment, a frozen dessert product can be made by making a frozen dessert composition comprising forming a mixture by combining together (i) one or more stabiliser and emulsifiers, (ii) one or more monounsaturated vegetable oil, (iii) one or more skim milk and milk derived solids, and (iv) one or more carbohydrate ingredients; pasteurizing the mixture, and preferably homogenising the pasteurized mixture, preferably spraying dry the mixture into powder, and then preferably reconstituting the ready-to-use powdered mixture in preferably 2-3 portions of water. The reconstituted mixture can be hydrated and preferably whipped and preferably frozen.

### DESCRIPTION OF THE INVENTION

The composition of the present invention is prepared by using a modified milk that comprises or is “filled” with high monounsaturated oleic acid vegetable oil.

Prior to the present invention, attempts to use vegetable oil filled milk to make a frozen dessert like ice cream were unsuccessful due to poor product stability, poor texture, poor mouthfeel and poor taste.

### Monosunsaturated Fatty Acid (MUFA)

Using natural vegetable oil alone instead of milk fat to make a frozen dessert is difficult. This is particularly the case if ordinary non-milk extrinsic sugar is also not used to make the dessert.

One selection criteria of a fat source for frozen desserts is that the fat droplet preferably contains an intermediate ratio of liquid: solid fat at the time of freezing of: about ½ to ⅔ crystalline fat at 4-5° C. It is very difficult however to achieve these ratios using alternative fat sources such as vegetable oils, since most vegetable oils have a low melting point. This means that hydrogenation of the vegetable oil is often necessary to achieve the appropriate melting characteristics of the end product. However, hydrogenation is undesirable since unhealthy trans fatty acids are often derived from the hydrogenation process.

The present invention seeks to avoid the use of hydrogenated vegetable oil and instead successfully uses non-hydrogenated high oleic acid vegetable oil which has an average melting point of lower than −10° C., much lower than that of milk fat at 37° C. (melting range: +40° C. to −40° C., thus always a combination of liquid and crystalline fat).

According to the present invention the preferred source of monounsaturated fatty acids is a non-hydrogenated high oleic acid vegetable oil. Vegetable oils which comprise high amounts of oleic acid include, for example, olive oil, tea oil, certain varieties of sunflower seed oil, safflower oil and canola oil.

Most preferably the vegetable oil is sunflower seed oil, canola oil or a mixture thereof. Preferably the vegetable oil has a monounsaturated fat content of at least 80%. More preferably the vegetable oil has a monounsaturated fat content of at least 84%, more preferably, 85%, 86%, 87%, 88%, 89% or 90% or more. The inventors have found that these preferred monounsaturated vegetable oils can be used to make a product that is stable and has the desired organoleptic qualities, such as creaminess, taste, iceness, smoothness, texture and hardness.

Preferably the vegetable oil accounts for about 4.5 to 6.5% by weight of the composition. More preferably the vegetable oil provides 4.5% to 6.0% by weight of the composition. The vegetable oil can provide about 4.5, 5.0, 5.5, 6.0 or 6.5% by weight of the composition.

### Skim Milk and Non-Fat Milk Solids

Preferably the content of milk fat in the composition is less than 0.5%, more preferably less than 0.45%, more preferably less than 0.4%, more preferably less than 0.35%, more preferably less than 0.3%, more preferably less than 0.25%, and more preferably less than 0.2%. In one embodiment the milk fat content is about 0.26%. Milk fat content is present in for example skim milk powder, whey powder, butter fat and milk fat zymolytes.

The skim milk may be fresh skim milk, concentrated skim milk, skim milk powder, or a mixture thereof. Preferably, the skim milk is fresh skim milk. Preferably skim milk solids account for about 4.5% to 10.9% by weight of the composition. More preferably skim milk solids account for about 5.5% to 9.5% by weight of the composition. The skim milk solids can account for about 5.5, 6.0, 6.5, 7.0, 7.5, 8.0, 8.5, 9.0 or 9.5% by weight of the composition or any range therein.

In one embodiment the composition contains a total solid content of about 30% to 35% by weight. Preferably the skim milk solids account for about 15% to 31% of total solid of the composition and said milk derived solids account for about 9% to 22% of total solid (or up to 50% of milk protein).

Preferably the milk derived solid is selected from sweet whey, modified whey, whey protein concentrate and mixtures thereof. It is found that partly replacing skim milk solid with milk derived solid helps improve overrun, creaminess and mouthfeel. Preferably the milk derived solid is demineralised whey powder. Preferably the ratio of skim milk solid to milk derived solid is about 1-3:1 by weight.

Preferably, milk derived solids account for about 2.7% to 7.7% by weight of the composition, more preferably about 3% to 6% by weight of the composition. The milk derived solids can account for about 2.7, 3.0, 3.5, 4.0, 4.5, 5.0, 5.5, 6.0, 6.5, 7.0 or 7.7% by weight of the composition or any range therein.

If a non soft serve ice cream is prepared, preferably the milk derived solid is also lactose-reduced whey powder. Preferably lactose content is less than 55%, most preferably less than 45%, by weight of the whey powder to prevent the product from ice crystalization during storage and handling.

### Carbohydrates

The composition of the present invention comprises one or more low GI carbohydrates. Preferably the carbohydrate ingredients accounts for about 9% to 17% by weight of the composition, more preferably about 9% to 16%, more preferably about 10% to 15% and more preferably about 11% to 13% by weight of the composition. The carbohydrate ingredients can account for about 9, 10, 11, 12, 13, 14, 15, 16 or 17% by weight of the composition or any range therein.

Most preferably the composition of the present invention comprises only non-sugar carbohydrate bulking ingredients and high intensive sweeteners to replace sugar, honey and syrup which are normally used to achieve technical attributes such as freezing point depression as well as taste. Preferably the composition of the present invention does not comprise non-milk extrinsic sugar, i.e. more preferably any additional extrinsic sugar, wherein “extrinsic sugar” refers to sugars that are not bound into a cellular structure, e.g. honey and table sugar. The lactose in dairy products is also extrinsic sugar, a milk extrinsic sugar.

In one embodiment non-sugar carbohydrate bulking agents include for example natural sugar alcohols, dietary fibre and other carbohydrate(s) or a mixture thereof. Preferably the mixture comprises 38% to 78% sugar alcohol and 15% to 44% dietary fibre and 15% to 22% other carbohydrate(s).

A sugar alcohol (also known as a polyol, polyhydric alcohol, or polyalcohol) is a hydrogenated form of carbohydrate, whose carbonyl group (aldehyde or ketone, reducing sugar) has been reduced to a primary or secondary hydroxyl group. They are used for replacing sucrose in foodstuffs, often in combination with high intensity artificial sweeteners to counter the low sweetness.

Preferably the sugar alcohol is selected from, for example, sorbitol, xylitol, lactitol, erythritol, mannitol, isomalt or a mixture thereof.

Preferably the dietary fibre is a substantially soluble dietary fibre. Preferably the dietary fibre comprises 90% water soluble dietary fibre.

In a preferred embodiment the dietary fibre comprises a resistant starch. Preferably the resistant starch/dietary fibre has a low GI value. Resistant starches include those that naturally exist and those that are manufactured, synthesized or modified.

In a preferred embodiment the soluble dietary fibre comprises a resistant maltodextrin, preferably in an amount of equal to or more than 3% by weight of the product. As used herein such an ingredient can be referred to as a source of fibre. Preferably the dietary fibre comprising resistant starch has solubility properties which also confer some stability to the product. Most preferably the dietary fibre has a fine and smooth mouth feel.

Other carbohydrate(s) refer to for example polydextrose, oligofructose, inulin and mixtures thereof. These carbohydrate are selected as bulking agents in place of sugar and help with proper freezing point and mouthfeel, and possess health benefits such as those provided by soluble dietary fibre.

In one embodiment a combination of non-sugar carbohydrate bulking agents is sorbitol/xylitol/polydextrose/resistant maltodextrin. An alternate combination of carbohydrates is sorbitol/lactitol/polydextrose/resistant maltodextrin or xylitol/sorbitol/oligofructose/resistant maltodextrin.

Preferably the combination of non-sugar carbohydrate bulking agents is sorbitol/xylitol/polydextrose/resistant maltodextrin. Preferably the combination of carbohydrates is provided in a ratio of about 5:1:1:3.

Most preferably, the selected non sugar carbohydrate ingredients are low GI and calorie reduced. For example the following sugar alcohols: sorbitol, xylitol, lactitol, erythritol, mannitol and isomalt have GI≦10, and a caloric value of 0.2-2.6 kcal/g. Polydextrose has a low GI, and caloric value of 1 kcal/g (SPI Polyols, Deis 2005). Oligofructose/inulin has a low GI, and caloric value of 1-2 kcal/g (Sensus America LLC). One preferred resistant starch is Fibersol®-2, by Matsutani Chemical Industry. Fibersol®-2 is a resistant maltodextrin containing 90% water soluble dietary fibre, it is slowly fermented in the large intestine, and it has a caloric value of 1-1.5 kcal/g. Fibersol®-2 is reported to be more freeze-thaw stable than maltodextrin and to have an improved after-taste of foods with high intensity sweeteners.

Preferably the carbohydrates together with the stabiliser/emulsifier system used in the present invention delivers a texture and mouthfeel, melting resistance and overrun similar to a control composition comprising sucrose/maltodextrin (at 12:3 ratio).

### Stabilisers and Emulsifiers

The composition of the present invention also comprises stabilisers and emulsifiers. Preferably the stabilisers and emulsifiers account for about 0.4% to 0.7% by weight of the composition.

According to the present invention stabilisers are used to make the composition and preferably the end frozen product stable as well as to help provide a preferred texture and melting resistance of the end product. Most preferably, a stable product is one which doesn't separate during processing (ageing) and has retarded or reduced ice and lactose crystal growth during storage.

Preferably for the present invention the stabilizer is selected from for example, sodium alginate, disodium phosphate, carrageenan and mixtures thereof. One preferred stabilizer is sodium phosphate. A preferred mixture comprises sodium alginate and disodium phosphate.

Disodium phosphate, together with sodium alginate, stabilises the product mix during aging and preferably prevents whey separation during manufacture. This ingredient may not be necessary for example in a reduced milk fat ice cream product in which the protein/fat and thus the whole system is more stable. It is proposed that the addition of disodium phosphate improves the stability of casein micelles by maintaining a salt balance and reducing the amount of free calcium in the mix, as well as decreasing the tendency for fat to coalescence.

Carrageenan can also be used in place of alginate and disodium phosphate to prevent whey separation during aging. It is thought that carrageenan also provides its stabilizing effects due to its reactivity with casein micelles and water gelling capabilities. Other gums or stabilisers with similar properties may also be used to produce the frozen dairy product of the present invention.

For vegetable fat ice cream that contains high unsaturated fatty acid content, the risk of oxidation and production of off-flavors during storage may be increased, which proposes a stability issue. The present invention overcomes this problem. This may be partially explained by the high monounsaturated fatty acid profile (being more stable compared to high polyunsaturated fatty acid) in combination with the stabilizers.

In one embodiment the product was found to have no iciness or off-flavour after 5 months of storage at under −18° C. The acid value and peroxide value of the product after 5 month storage showed no significant difference from those after 3 month storage under −18° C.

An antioxidant may also optionally be included in the composition to provide a longer shelf life. Preferably natural antioxidants are used. Preferably the natural antioxidants are selected from vitamin E, vitamin C and mixtures thereof.

According to the present invention an emulsifier is also preferably included. Emulsifiers that can be used in ice cream include for example diacetyltartaric and fatty acid esters of glycerol, lecithin, mono-and di-glycerides of fatty acids, polyglycerol esters of fatty acids, polysorbate 60 or polyoxyethylene (20) sorbitan monostearate, polysorbate 65 or polyoxyethylene (20) sorbitan tristearate, polysorbate 80 or polyoxyethylene (20) sorbitan monooleate, sodium stearoyl lactylate, sorbitan monostearate, sucrose esters of fatty acids and sodium caseinate.

Preferably the emulsifier is selected from for example mono and diglycerides, polysorbate 80, lecithins or mixtures thereof.

In one embodiment the stabilisers and emulsifiers comprise a combination of vegetable gums, sodium alginate, sodium phosphate, mono and diglycerides, lecithins and carbohydrate texture modifier. Stabilizer and emulsifier combinations that are non-animal based and commercially available for frozen dessert such as ice cream include for example: Sodium alginate/guar gum/mono and diglycerides; sodium carboxymethylecellulose/guar gum/propane di-eaters of fatty acids/mono diglycerides; and Xanthan gum/guar gum/mono diglycerides.

One preferred combination of stabilisers and emulsifiers namely vegetable gums (sodium carboxymethylecellulose, guar gum, locust bean gum), sodium alginate, disodium phosphate, and mono and diglycerides and lecithins as well as maltodextrin was found to provide a product having desirable characteristics such as iciness, smoothness, hardness and melting resistance similar to a regular ice cream product with the same percentage of milk fat (6%) and added sugar.

In one preferred embodiment of the invention, the stabilizers and emulsifiers are present in amounts of about 20% to 24% vegetable gums, about 7% to 9% sodium alginate, about 6% to 9% sodium phosphates, about 20% to 27% mono and diglycerides, about 4% to 11% lecithins, and about 23% to 32% carbohydrate texture modifier including, for example, modified starch, maltodextrin and mixtures thereof.

### Flavour and Sweetener

Another challenge of the combined vegetable oil and sugar substitutes in this invention is how to achieve a creamy taste that is comparable to a conventional product having the same percentage of milk fat and sugar.

According to the present invention, milk flavour enhancers such as for example butter, milk fat extract, milk fat zymolytes, milk flavourings and mixtures thereof can be used to provide a creamy taste. Preferably the milk flavour enhancers are natural and provide for about 0.4% to 0.6% by weight of the product. It is preferred that few un-natural flavours are used. Rich and intense natural dairy flavours are preferred to minimise the usage rate. It is preferred that milk fat zymolytes, such as lipolysed cream paste are added for enhancement of creaminess. In another embodiment lecithins in the range of 0.03 to 0.08% by weight are found to be helpful in providing a creamy taste. Preferably all ingredients of the composition are low in cholesterol and low in saturated fat.

In another embodiment additional flavours can be used, such as for example vanilla flavour. In this case, vanilla flavour may be added in any amount suitable, such as about 0.2% by weight of the product. Other flavours can also be used with flavoured dessert such as ice cream, any of which would be suitable for using in the present invention.

High intensive sweeteners include, for example, sucralose, aspartame, acesulfame K or a mixture thereof. In one embodiment the high intensive sweetener is preferably present in an amount of about 0.01%-0.02% by weight of the product.

### Other Food Additives

It is envisaged that other food additives such as for example acidity regulators, preservatives, colours, flavours, antioxidant and anti-caking agent can be included in the product as necessary.

### Properties of Ice Cream

In a preferred embodiment of the present invention the frozen dessert product is a conventional ice cream. Various types of ice cream are described as being soft serve, spoonable or block in form.

According to the present invention the ice cream preferably has one or more properties that are similar to a comparable ice cream i.e. an ice cream made with the same percentage of milk fats and sugar, (referred to now as “a regular milk fat and sugar ice cream”). Preferably the term “similar” refers to not being statistically significantly different, as measured in the Examples of the present specification.

For example, in a preferred embodiment the protein content of the product of the present invention is similar to a regular milk fat and sugar ice cream.

In a preferred embodiment the % overrun of the inventive product is similar to the % overrun of a regular milk fat and sugar ice cream. Overrun is a measure of the ability of a whipped dessert product to increase in volume during the whipping or mixing process. For example, a product that doubles in volume (i.e. one gallon to two gallons) is said to achieve 100% overrun. Regular milk fat and sugar ice cream products (products with ≧10% fat and sucrose/corn syrup solids), may achieve an overrun in excess of 100%. Both too high and too low overrun contribute to a poor texture and mouthfeel. A value of 2.5 folds of total solid value of a product is suggested to be appropriate. A soft serve ice cream may have an overrun of less than 50%. Among ingredient factors that impact overrun, sugar substitutes may lower it. The lower overruns of the non-sucrose desserts lowers the effective yield because whipped frozen desserts are sold by volume and not by weight.

In another embodiment the total solid content of the product of the present invention is similar to or less than the solid content of a regular milk fat and sugar ice cream.

Most preferably the product of the present invention has one or more similar orgenoleptic qualities, such as creaminess, after taste, iciness, body, texture and hardness as a regular milk fat and sugar ice cream made with the same percentages of milk fat and sugar.

In one embodiment the melting rate of the product of the present invention is similar to the melting rate of a regular ice cream.

### Preparation of Mixture and Ice Cream Product

The mixture of the present invention can be produced in liquid form or powder form that is ready to use for making the ice cream product.

A liquid mixture can be prepared by either pasteurisation or UHT treatment. A pasteurized mixture has a shelf life of about 2 weeks under refrigeration condition (2-4° C.) whereas a UHT treated mixture has a longer shelf life and can be stored and distributed at room temperature. For UHT treatment, the ingredients of the composition are mixed and aged for about 30 minutes. This mixture is then heated under UHT conditions for example at 135-140° C. for 2-4 seconds by direct steam injection, and then homogenised in a 2 stage process for example at 2900 psi and 500 psi (about 70° C.), respectively. The treated mixture can then be packaged aseptically.

A powdered mix can be prepared using a low-medium heat spray dry method. After thoroughly mixing all of the ingredients and then aging for about 30 minutes, the mixture is heated under pasteurisation conditions (eg 78-82° C. for about 5 minutes) or under ultra pasteurisation conditions (eg 121° C. for 2-4 seconds, direct steam injection). The mixture is then homogenised in a 2 stage process for example at 2900 psi and 500 psi (about 70° C.), respectively. The mixture is made into powder by use of a spray dry machine (eg inlet temperature 180° C. and outlet temperature 80° C.).

To make a soft serve ice cream from the powder mix a portion of the dry blend is mixed into about 2-3 portions of cold water or warm water (eg 30° C.) using rapid agitation, and allowing it to hydrate before pouring it into a soft-serve machine.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### EXAMPLES

### Example 1

Formulation 1 was used to Prepare a Soft Serve Ice Cream Product:

| Ingredient | Weight (grams) (total 100 g) |
|---|---|
| Skim milk powder | 6.55 |
| Whey powder | 7.00 |
| Natural high oleic acid sunflower seed oil | 5.52 |
| Natural sugar alcohol | 6.00 |
| Resistant maltodextrin Fibersol ®-2 | 3.00 |
| Polydextrose | 1.00 |
| Mono and diglycerides | 0.18 |
| Lecithins | 0.08 |
| Sodium carboxymethylecellulose | 0.10 |
| Sodium alginate | 0.06 |
| Guar gum | 0.03 |
| Disodium phosphate | 0.05 |
| Locust bean gum | 0.015 |
| Butter fat | 0.34 |
| Milk fat zymolytes BFI900, Tatua | 0.04 |
| Vanilla flavour | 0.04 |
| Sucralose | 0.015 |
| Water | 69.98 |

### Method

The stabiliser and emulsifier ingredients (in powder form) are mixed, added into 10-20 times the volume of water at 80° C. and mixed vigorously until completely dissolved. The oil is then added at 40° C. into the dissolved mixture and is thoroughly mixed. The emulsion of stabiliser, emulsifier and oil is then added into a reconstituted skim milk and whey powder (heating water to >30° C. before adding powder and allowing to hydrate for 15-30 minutes). Soluble fibre, sugar alcohol and polydextrose are dissolved in water and flavour ingredients are added into the mixture before pasteurisation. Aeration is avoided through the process. The mix is then pasteurised at 78-82° C. for about 5 minutes and then homogenised (70° C.) in a 2 stage process at 2900 psi and 500 psi for the first and second stages, respectively. The mix is cooled and held overnight at 4° C. for aging before being frozen in a “Taylor” batch freezer and served as soft serve ice cream. It can also be hardened at temperature lower than −18° C. and served as “spoonable” ice cream. The properties and sensory evaluation of the formulation are compared to controls as shown in Table 1 and Table 2, respectively.

TABLE 1
Properties of ice cream samples

| | Formulation 1 | Control 1 | Control 2 | Control 3 |
|---|---|---|---|---|
| | Mono oil & | Milk fat & | Mono oil & | Milk fat & |
| | no-sugar-added | no-sugar-added | sugar added | sugar added |
| Fat % m/m | 7 | 6 | 7 | 6 |
| Protein % m/m | 3.3 | 3.2 | 3.2 | 3.2 |
| Total solids % m/m | 29.4 | 29.7 | 32.6 | 35.4 |
| Viscosity cP | 28.4 | 27.6 | 41.0 | 44.8 |
| (LV/S61, RPM: 60) | | | | |
| Before aging | | | | |
| After overnight | 58.7 | 48.9 | 77.4 | 84.1 |
| aging | | | | |
| Draw temperature | −6.5 | −6.0 | −6.5 | −6.0 |
| ° C. | | | | |
| Frozen time | 5′31″ | 6′20″ | 6′10″ | 5′47″ |
| Min′Sec″ | | | | |
| Overrun % | 58.9 | 57.5 | 59.0 | 54.6 |
| Melting rates* %/min | 1.75a | 1.25 | 1.97a | 1.78a |

*modified method of Tharp BW, Forrest B, Swan C, Dunning L and Hilmoe. Basic factors affecting ice cream meltdown. In Ice Cream. Buchheim Wed. International Dairy Federation Special Issue 9803. 1998; 54-64. International Diary Federation, Brussels, Belgium.
a: significantly different from that of Control 1, t test p < 0.05.

### Overrun Measurement:

A volume of ice cream mix is weighed before production. The ice cream mix is then processed. After processing the set volume produced from the mix is weighed. The ice cream should be level when the readings are taken to ensure accuracy. From these figures the overrun can be calculated (weight of mix before processing-weight of mix after processing)/weight of mix after processing).

TABLE 2
Sensory evaluation of ice cream samples (average scores*)

| | | Control 1 | | |
|---|---|---|---|---|
| | Formulation 1 | Milk fat & | Control 2 | Control 3 |
| | Mono oil & | no-sugar- | Mono oil & | Milk fat & |
| | no-sugar-added | added | sugar added | sugar added |
| Creaminess | 4.4ab | 6.1 | 4.8a | 5.5 |
| After taste | 4.8 | 5.7 | 4.8 | 5.7 |
| Iciness | 2.8 | 2.3 | 2.5 | 2.0 |
| Smooth | 5.0 | 6.1 | 5.5 | 5.9 |
| body & | | | | |
| texture | | | | |
| Hardness | 4.2b | 4.6 | 4.9 | 5.8 |

*A score of 0-9 was used. For creaminess: 0 as very light and 9 as very heavy; For after taste: 0 as very weak and 9 as very strong; For iciness: 0 as not icy and 9 as very icy; For smooth body & texture: 0 as not smooth 9 as very smooth; For hardness: 0 as very soft and 9 as very hard. Average scores of a 6-member panel were presented on the table.
a: significantly different from that of Control 1, t test p < 0.05;
b: significantly different from that of Control 3, t test p < 0.05.

From Tables 1 and 2, it is evident the ice cream of Formulation 1 provides a texture and mouthfeel similar to that of the controls. The hardness of Formulation 1 is similar to that of Control 1 & 2, but less than the Control 3.

The overrun of Formulation 1 is also comparable to that of the controls although Example 1 is about 3-6% by weight less than Control 2 and 3 (for the part of carbohydrate ingredients), and about 3-6% less therefore in total solid content which lowers viscosity of the mix before aging by >30% and after aging by >24% (improved viscosity), compared to Control 2 & 3.

Other factors which may have compensated for the effect of lower viscosity in Formulation 1 are the stabilisers used. The stabilisers for example may provide a better overrun with the selected sugar substitutes. The melting rate in Example 1 is similar to that of regular milk fat and sugar added product (Control 3). The higher melting resistance associated with Control 1 indicates a nestification effect of the non-sugar carbohydrate component and milk fat on melting resistance. The decrease in total solid content is a cost-saving feature. The creaminess score of Formulation 1 is less than that of the Controls with milk fat. However it can still be argued that a similarity in creaminess between the Example 1 and milk fat controls was achieved as all the controls have been prepared using the same creaminess enhancers as those in Formulation 1.

The product of Formulation 1 comprises 6% fat. Out of the 6% in total, milk fat is 0.26% (from skim milk powder, whey powder, butter fat and milk fat zymolytes). The following table gives nutritional information by calculation from ingredients:

Nutritional Information for Formulation 1

| | | | Label claim (based on US |
|---|---|---|---|
| | Per 100 g | | requirements) |
| Energy | 122 kcal | | Reduced calories: 25% or less |
| | (512 KJ)* | | calories per serving than regular |
| | | | product (8% fat, 3% protein and |
| | | | 20% carbs, making a total calories |
| | | | of 164 kcal/100 g) |
| Protein | 3.1 | g | |
| Total fat | 6.0 | g | Reduced fat: 25% or less fat per |
| | | | serving than regular product (8% |
| | | | fat) |
| Monounsaturated fat | 4.8 | g | |
| Polyunsaturated fat | 0.3 | g | |
| Saturated fat | 0.9 | g | Low saturated fat: Less than or equal |
| | | | to 1 g per serving |
| Trans fat | 0.0 | g | |
| Cholesterol | 3.6 | mg | Low cholesterol: Less than or equal |
| | | | to 20 mg and less than or equal to 2 g |
| | | | saturated fat per serving |
| Total carbohydrate | 19.2 | g | |
| Dietary fabre | 3.0 | g | |
| Sugar (lactose) | 9.1 | g | |
| Sugar alcohol | 6.0 | g | |

*Calories: from protein 12.4 kcal, from fat 54 kcal, from carbohydrate 55.7 kcal. As resistant starch and sugar alcohols have reduced calorie (1-2.6 kcal/g compared to 4 kcal/g from sugar), the calories from total carbohydrate are reduced from 76.8 kcal to 55.7 kcal.

1. A frozen dessert composition comprising
(a) skim milk solids in a total amount of about 4.5% to 10.9% by weight of the composition,
(b) milk derived solids in a total amount of about 2.7% to 7.7% by weight of the composition,
(c) vegetable oil high in monounsaturated fatty acids in a total amount of about 4.5% to 6.5% by weight of the composition,
(d) low GI carbohydrates in an amount of about 9% to 17% by weight of the composition,
(e) one or more stabiliser,
(f) one or more emulsifier, and
(g) optionally one or more flavour.

2. The frozen dessert composition according to claim 1, wherein the vegetable oil is an oleic acid non-hydrogenated vegetable oil.

3. The frozen dessert composition according to claim 1, wherein the vegetable oil has a monounsaturated fat content of at least 80%.

4. The frozen dessert composition according to claim 1, wherein the low GI carbohydrates comprise a mixture of natural sugar alcohol, dietary fibre and other carbohydrates.

5. The frozen dessert composition according to claim 1 wherein the low GI carbohydrates comprise about 38% to 78% natural sugar alcohol, about 15% to 44% dietary fibre and about 15% to 22% other carbohydrates.

6. The frozen dessert composition according to claim 4, wherein the sugar alcohol is selected from, for example, sorbitol, xylitol, lactitol, erytheritol, mannitol, isomalt or a mixture thereof.

7. The frozen dessert composition according to claim 4, wherein the dietary fibre comprises 90% water soluble dietary fibre.

8. The frozen dessert composition according to claim 4, wherein the dietary fibre comprises a resistant starch.

9. The frozen dessert composition according to the claim 7 wherein the soluble dietary fibre comprises a resistant maltodextrin.

10. The frozen dessert composition according to claim 4, wherein the other carbohydrates include, for example, polydextrose, oligofractose, inulin and mixtures thereof.

11. The frozen dessert composition according to claim 4, the combination of non-sugar carbohydrate bulking agents include sorbitol, xylitol, polydextrose and resistant maltodextrin.

12. The frozen dessert composition according to claim 1, comprising less than 0.5% milk fat, preferably less than 0.45% milk fat, more preferably less than 0.4%, more preferably less than 0.35%, more preferably less than 0.3%, more preferably less than 0.25%, and more preferably less than 0.2%.

13. The process of using a frozen dessert composition, comprising
(a) skim milk solids in a total amount of about 4.5% to 10.9% by weight of the composition,
(b) milk derived solids in a total amount of about 2.7% to 7.7% by weight of the composition, (c) vegetable oil high in monounsaturated fatty acids in a total amount of about 4.5% to 6.5% by weight of the composition,
(d) low GI carbohydrates in an amount of about 9% to 17% by weight of the composition,
(e) one or more stabiliser,
(f) one or more emulsifier, and
(g) optionally one or more flavour, in the preparation of a mixture suitable for making a frozen dessert product.

14. A method of making a frozen dessert composition comprising forming a mixture by combining together (i) one or more stabiliser and emulsifiers, (ii) monounsaturated vegetable oil, (iii) skim milk and milk derived solids, and (iv) carbohydrate ingredients.

15. The method of claim 14 for making a frozen dessert product further comprising pasteurizing the mixture, homogenising the pasteurized mixture and cooling, aging and then freezing the pasteurized mixture.
